(19) United States
(12) Patent Application Publication
(10) Pub. No.: US 2009/0322748 A1
(43) Pub. Date: Dec. 31, 2009

(54) Methods,systems, and computer program products for GPU-based point radiation for interactive volume sculpting and segmentation

(75) Inventors: Hung-Li Jason Chen, Calgary (CA); Faramarz F. Samavati, Calgary (CA); Mario Costa Sousa, Calgary (CA)

Correspondence Address: FULBRIGHT & JAWORSKI L.L.P., 600 CONGRESS AVE., SUITE 2400, AUSTIN, TX, 78701, US

(73) Assignee: UTI Limited Partnership

(21) Appl. No.: 12/455,948

(22) Filed: Jun. 9, 2009

Related U.S. Application Data
(60) Provisional application No. 61/131,594, filed on Jun. 9, 2008.

(51) Int. Cl. G06T 17/00

(52) U.S. Cl. 345/424

(57) ABSTRACT

Internal structures, features and properties in volumetric datasets are mostly obscured and hidden. In order to reveal and explore them, appropriate tools are required to remove and carve the occluding materials, isolate and extract different regions of interest. A framework of interactive tools are provided for real-time volume manipulation, sculpting, segmentation, and visualization. A GPU-based point radiation technique provides as a fundamental building block to create a collection of high-quality volume manipulation tools for direct drilling, lasering, peeling, cutting, and/or pasting. Interactive parallel region growing segmentation is described that allows multiple seeds planting by direct sketching on different volumetric regions with segmentation results dynamically modified during the process. The point radiation technique creates high-quality real-time feedback of the segmented regions during the seeded growing process.

### CROSS-REFERENCE TO RELATED APPLICATIONS

This application claims priority to U.S. Provisional Application No. 61/131,594 filed Jun. 9, 2008, the entire disclosure of which is incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to volumetric visualization. More particularly, the present invention relates to interactive volumetric manipulation, sculpting, segmentation, and visualization of volumetric data sets.

### BACKGROUND OF THE INVENTION

In medical imaging, clinicians and surgeons often use computer-aided techniques to identify and analyze anatomical structures of interest. Many techniques were developed in particular for segmentation (see survey by Pham, D. L. et al., “A Survey of Current Methods in Medical Image Segmentation,” Technical Report JHU/ECE 99-01, (1999)). In Sherbondy, A. et al., “Fast Volume Segmentation With Simultaneous Visualization Using Programmable Graphics Hardware,” Proc. of IEEE Visualization, pp 171-176 (2003), a proposal is provided for navigating from 2D images to place a seed point. This point is used for a seeded region growing algorithm for determining the area of interest. This kind of technique has three major issues to be addressed: how to navigate, how to plant the seeds, and how to control the growing threshold. Current medical volume datasets contain hundreds of slices and require domain expertise for understanding the cross-sectional representation. An ideal segmentation environment would simulate physical tools allowing users to directly operate on 3D datasets and carve them.

The second issue is how to plant the seeds. Due to the noise in the medical image acquisition process, materials with similar intensity values are sometimes disconnected, resulting in an incomplete segmentation of the entire organ. It would be beneficial to perform region growing on a group of the seeds in a parallel fashion.

The third issue is how to control the region growing algorithm. Using the static thresholding methods is not an ideal solution since different material in the dataset can have very close intensity values. This is an issue and requires a trial and error process for tweaking the thresholds. Addressing all of these issues, in addition to real-time feedback and high-quality rendering, makes the problem even more challenging.

Accordingly, it is desirable to provide methods and software-related tools that overcome these problems.

### BRIEF SUMMARY OF THE INVENTION

As described herein, the present embodiments relate to methods, systems, and computer program products that provide a framework of interactive tools for real-time volume manipulation, sculpting, segmentation, and visualization. A Graphics Processing Unit (GPU)-based point radiation technique is introduced as a building block for high-quality volume carving. The point's radiation is used to create smooth anti-aliased results as well as a collection of interactive raycasting based tools for direct drilling, lasering, peeling, cutting, and/or pasting the 3D volume using a sketch-based interface.

Methodologies and/or techniques are provided for interactive region growing segmentation and multiple seeds planting by direct sketching on different regions. To obtain rapid feedback, a parallel region growing technique is described to concurrently operate on all the sketched seeds. The parallel region growing technique allows segmentation results to be dynamically modified through a series of undo, redo, and resume operations.

In an embodiment, seeds are processed as points using programmable hardware. Multiple seeds can be maintained by storing their state information in a separate 3D buffer. Point radiation is utilized to create an anti-aliased seed map and render the region growing result with high-quality raycasting.

The above described and many other features of the present embodiments will become apparent, as the embodiments becomes better understood by reference to the following detailed description when considered in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments are illustrated in the figures of the accompanying drawings, which are meant to be exemplary and not limiting, in which like reference numbers indicate identical or functionally similar elements, additionally in which the leftmost digit(s) of a reference number identifies the drawing in which the reference number first appears, and in which:

FIG. 1 illustrates a schematic block diagram of one embodiment of a computer system that may be used to implement certain embodiments of the present methods, systems, and computer-readable media.

FIG. 2 illustrates a flowchart of on embodiment of the present methods for interactive volume manipulation, sculpting, segmentation, and visualization.

FIG. 3A-3E illustrates peeling and segmentation of a super-brain dataset;

FIG. 4 illustrates reconstructing a set of 3D footprint voxels from 2D point sprites;

FIGS. 5A-5B illustrate operating a point radiation GPU-based drilling tool on a super-brain dataset;

FIGS. 6A-6B illustrate operating a point radiation GPU-based lasering tool on super-brain dataset;

FIGS. 7A-7B illustrate operating a point radiation GPU-based peeling tool on a super-brain dataset;

FIG. 8 illustrates an overview of a GPU-based segmentation framework;

FIGS. 9A-9B illustrates partial segmentation of ventricles using a binary segmentation map without point radiation and with point radiation;

FIGS. 10A-10D illustrates seed sketching and segmentation of carotid and cerebral arteries from an angiography dataset;

FIG. 11A illustrates peeling of the skull and segmentation of the left and right lateral ventricle from the super-brain dataset of FIG. 3;

FIG. 11B illustrates peeling of abdominal wall and segmentation of the colon from an abdomen dataset; and

FIG. 11C illustrates lasering, drilling, and segmentation of a molar tooth from a skull dataset.

### DETAILED DESCRIPTION OF ILLUSTRATIVE EMBODIMENTS

In the following description of the several embodiments, reference is made to the accompanying drawings that form a part hereof and in which is shown by way of illustration a number of specific embodiments. It is to be understood that other embodiments can be utilized and structural changes can be made without departing from the scope of the present invention.

Methods, systems, computer program products are described herein for GPU-based point radiation for interactive volume sculpting and segmentation, which includes a framework of interactive tools for real-time volume sculpting and segmentation.

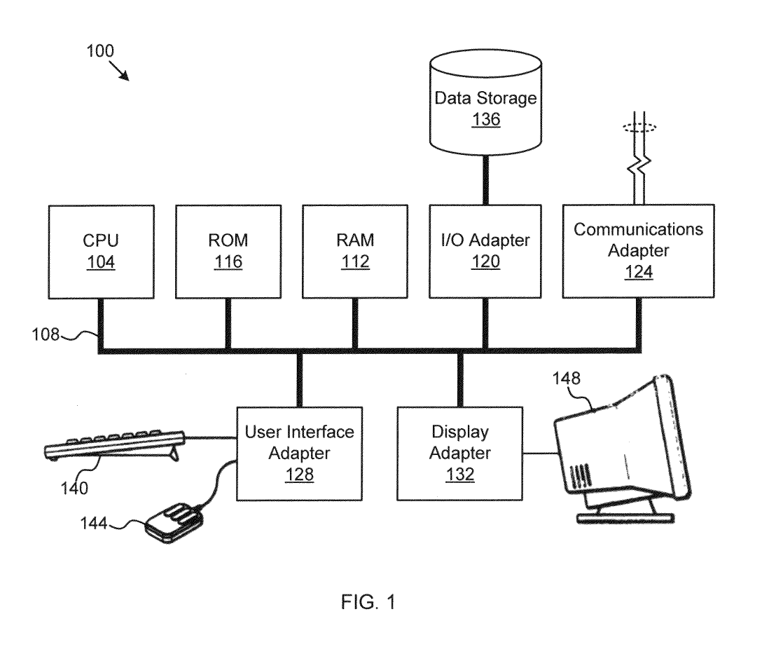

FIG. 1 illustrates a computer system 100. A central processing unit (CPU) 104 is coupled to the system bus 108. CPU 104 may be a general purpose CPU or microprocessor. In a further embodiment, the CPU 104 comprises a Graphics Processing Unit (GPU). In such an embodiment, the GPU may include a microprocessor coupled to, or comprising, a graphics card dedicated to calculating floating point operations, and the like. Alternatively, the microprocessor may include a graphics accelerator or an integrated graphics processing portion. The present embodiments are not restricted by the architecture of the CPU 104, so long as the CPU 104 supports the modules and operations as described herein. The CPU 104 may execute the various logical instructions according to the present embodiments. For example, CPU 104 may execute machine-level instructions according to the illustrative operations described in this disclosure.

The computer system 100 can also include Random Access Memory (RAM) 112, which may be SRAM, DRAM, SDRAM, or the like. Computer system 100 may utilize RAM 112 to store various data structures used by a software application configured to perform or operate any of the methods, steps, and/or computer-readable media. Computer system 100 may also include Read Only Memory (ROM) 116 which may be PROM, EPROM, EEPROM, optical storage, or the like. The ROM may store configuration information for booting the computer system 100. RAM 112 and ROM 116 are configured to hold or store user and/or system data.

The computer system 100 can also include an input/output (I/O) adapter 120, a communications adapter 124, a user interface adapter 128, and a display adapter 132. The I/O adapter 120 and/or user the interface adapter 128 can, in certain embodiments, enable a user to interact with the computer system 100, such as, for example, to input information or data. In a further embodiment, the display adapter 132 can display a graphical user interface associated with a software or web-based application for implementing any of the present methods and/or steps described in this disclosure.

In one embodiment, the I/O adapter 120 can connect to one or more storage devices 136, such as one or more of a hard drive, a Compact Disc (CD) drive, a floppy disk drive, a tape drive, to the computer system 100, and/or to any other drive or communications port for coupling to or interacting with computer-readable media (e.g., tangible computer-readable media such as, for example, CD-ROM, CD+/−RW, flash drives, portable hard drives, and the like). As such, it should be noted that any of the present methods can be embodied in a computer program product comprising a computer-readable medium having a computer-readable program code embodied therein, the computer-readable program code adapted to be executed to implement any of the present methods for interactive volume manipulation, sculpting, segmentation, and visualization.

In one embodiment, the Communications adapter 124 can be configured or adapted to couple computer system 100 to a network (e.g., internet, LAN, WAN, or the like). User interface adapter 128 couples user input devices, such as a keyboard 140 and/or pointing device 144, to computer system 100. Display adapter 132 may be driven by CPU 104 to control the display on a display device 148.

The present embodiments are not limited to the architecture of system 100. Rather computer system 100 is provided as an example of one type of computing device that may be adapted to perform or operate any of the methods, steps, and/or computer-readable media described in the present disclosure. For example, any suitable processor-based device may be utilized including without limitation, including personal digital assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

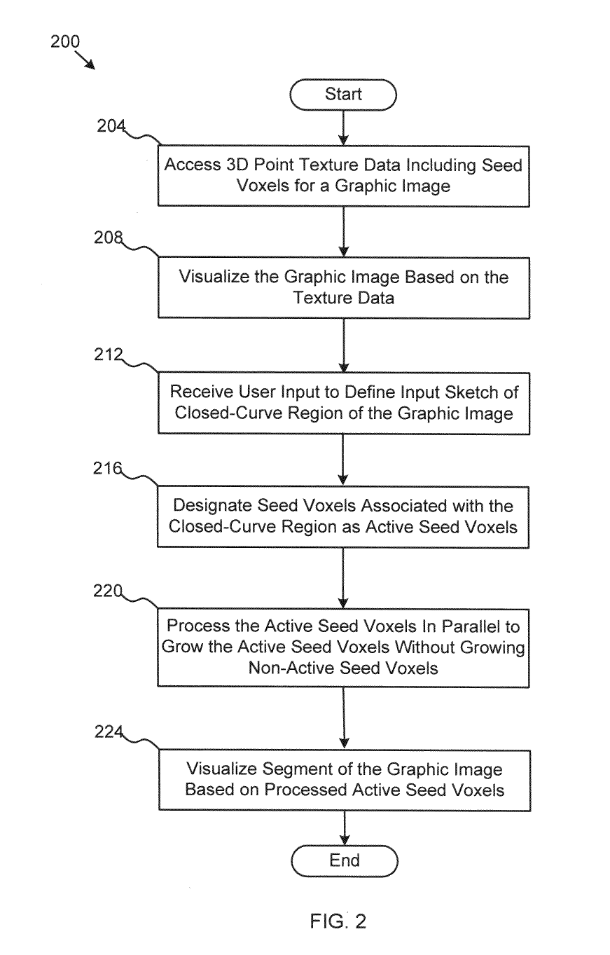

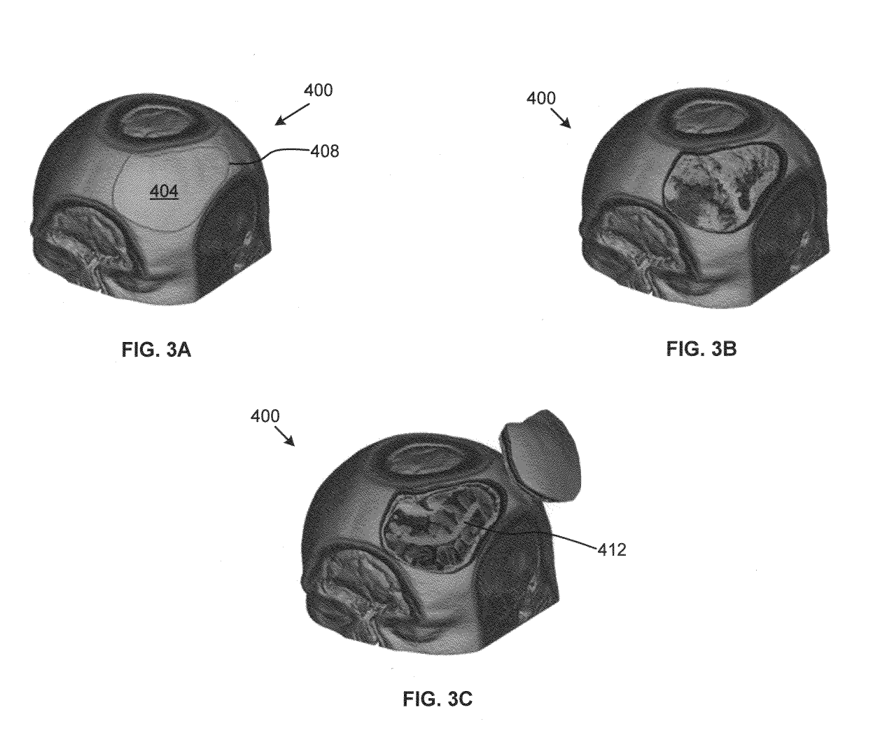

FIG. 2 illustrates a flowchart of an embodiment of the present methods for interactive volume manipulation, sculpting, segmentation, and visualization. In one embodiment, the method 200 comprises: step 204 that includes accessing three-dimensional point texture data including a plurality of seed voxels for a graphic image (e.g., from RAM 112 and/or ROM 116 of system 100 in FIG. 1); step 208 that includes visualizing the graphic image on a user interface based on the texture data (see, e.g., FIG. 3A); step 212 that includes receiving user input to define an input sketch specifying a closed-curve region of the graphic image (see, e.g., FIG. 3B-3C); step 216 that includes designating the seed voxels associated with the closed-curve region as active seed voxels (see, e.g., FIG. 3C); step 220 that includes processing the active seed voxels in parallel to grow each of the active seed voxels without growing seed voxels not designated as active voxels (see, e.g., FIG. 3D); and step 224 that includes visualizing a segment of the graphic image based on the processed active seed voxels (see, e.g., FIG. 3E).

FIGS. 3A-3E illustrate an implementation of the interactive volume manipulation framework according to an embodiment. FIGS. 3A-3E show a graphic image 400 of a human brain as visualized on a computer display, and follows a process for peeling and segmentation of a super-brain dataset. In FIG. 3A, a user, operating an input device in the computer graphics environment, indicates a region 404 for opening with a stroke of an input device (e.g., defining boundary 408). In FIG. 3B, a surface-based peeling operation is performed with user-specified depth. In FIG. 3C, the skull is removed and the user sketches a region of seeds for segmentation (e.g., with line or boundary 412). In FIG. 3D, the region 416 grows in accordance with the methods, and in FIG. 3E, the grey and white matter are segmented and isolated.

The GPU-based point radiation framework of the present embodiments may also include components and functionality that may relate to volume clipping, volume sculpting, and volume segmentation with seeded region growing. Volume clipping provides a means to expose parts of the volume with cutting planes or more complicated geometry. For example, in Weiskopf, D. et al., “Interactive Clipping Techniques for Texture-Based Volume Visualization and Volume Shading,” IEEE Transactions on Visualization and Computer Graphics 9(3), pp 298-312 (2003), interactive clipping techniques are proposed to exploit graphics hardware. They present depth-based clipping, using the depth structure of an object, as well as clipping via voxelized clip object, utilizing 3D textures and distance fields.

In McGuffin, M. et al., “Using Deformations for Browsing Volumetric Data,” Proc. of IEEE Visualization, pp 401-408 (2003), a method is presented that may be suitable for browsing a volume with interactive manipulation widgets by assigning individual voxels as the fundamental primitive. In Huff, R. et al., “Erasing, digging and clipping in volumetric datasets with one or two hands,” Proc. of the ACM International Conference on Virtual Reality Continuum and its Applications, pp 271-278 (2006), methods are described to exploit programmable hardware, and erasing, digging, and clipping operations are proposed to uncover hidden structures in the volume data. Recently, in Correa, C. D. et al., “Feature Aligned Volume Manipulation for Illustration and Visualization,” IEEE Transactions on Visualization and Computer Graphics 12, pp 1069-1076 (2006), a set of operators (peeler, retractors, pliers, dilators) are proposed that can be placed anywhere on or within the volume.

However, these previous approaches either require pre-constructed clipping objects or procedurally defined operators. And for most of the hardware-based clipping methods, the algorithm is computed in the context of 3D texture rendering, thereby requiring every voxel to be processed for every frame. In contrast, the present methods and systems, voxels are clipped and processed only if they are affected by the points emitted by the tool.

Volume Sculpting generally refers to a modeling technique for sculpting a solid material with a tool, which modifies values in the voxel array. Sculpting tools can be used to add, remove, paint, and/or smooth material. In Galyean, T. A. et al., “Sculpting: an interactive volumetric modeling technique,” Proc. of SIGGRAPH '91, pp 267-274 (1991), a 3D device is adapted to sculpt a block of material bit-by-bit with an additive tool, a heat gun, and sandpaper. In Avila, R. S. et al., “A Haptic Interaction Method for Volume Visualization,” Proc. of IEEE Visualization, pp 197-204 (1996), a 3D haptic device is incorporated to simulate virtual sculpting tools by applying 3D filters on the properties of the volume data. Ferley, E. et al., “Practical volumetric sculpting,” The Visual Computer 16, pp 469-480 (2000), includes a sculpting metaphor for rapid shape prototyping with 3D input devices. In general, sculpting with a 3D device can be a challenging task as parts of the volume can occlude the tool itself. Moreover, it can be difficult to visualize the 3D location of a virtual tool relative to the target volume. In Wang, S. W. et al., “Volume Sculpting,” Proc. of the 1995 Symposium on Interactive 3D Graphics, pp 151-156 (1995), a carving and sawing tool is described that utilizes a 3D splatting method with a hyper-cone filter. Their approach is primarily in the context of solid modeling.

With respect to volume segmentation, well-known segmentation techniques, such as thresholding, k-means clustering, watershed segmentation, and level-set methods, have been applied in segmenting volume datasets. In Tzeng, F.-Y. et al., “A Novel Interface for Higher-Dimensional Classification of Volume Data,” Proc. of IEEE Visualization '03, pp 505-512 (2003), an intuitive user interface is proposed for specifying high-dimensional classification functions by painting directly on sample slices of the volume. In Owada, S. et al., “Volume Catcher,” Proc. of the Symposium on Interactive 3D Graphics and Games, pp 111-116 (2005), a volume catcher system is developed for which the user traces the contour of the target region by drawing a 2D free form stroke over the displayed volume.

A seeded region growing method has been explored for segmenting volumes (see Justice, R. K. et al., “3-D Segmentation of MR Brain Images Using Seeded Region Growing,” 8th Annual International Conference of the IEEE Proceedings, pp 1083-1084 (1996)). In Sherbondy, A. et al., “Fast Volume Segmentation With Simultaneous Visualization Using Programmable Graphics Hardware,” Proc. of IEEE Visualization, pp 171-176 (2003), a volume segmentation system is discussed to allows a user to paint seeds by drawing on two-dimensional (2D) sectional views of a volume. However, selecting from hundreds of slices and pin-pointing a correct location on a 2D image requires highly trained personnel and a large amount of time.

In Chen, H. L. J. et al., “Sketch-Based Volumetric Seeded Region Growing,” Proc. of Eurographics Workshop on Sketch-Based Interfaces and Modeling 2006, pp 123-129 (2006), a 3D seeded region segmentation system is presented with splatting rendering. Chen, H. L. J. et al. allows volume cropping with a sketch-based interface, and enables seed searching directly on the 3D surface. The drawback in their seed selecting approach is that only one seed can be explored at a time and the region growing has to be computed off-line.

Recent approaches exploit programmable hardware for accelerating the region growing algorithm (see Sherbondy, A. et al., “Fast Volume Segmentation With Simultaneous Visualization Using Programmable Graphics Hardware,” Proc. of IEEE Visualization, pp 171-176 (2003), and Schenke, S. et al., “GPU-Based Volume Segmentation,” Proc. of Image and Vision Computing New Zealand '05, pp 171-176 (2005). The seed growing computations of Sherbondy, A. et al. and Schenke, S. et al. require rendering to sections of a 3D texture and must iterate through all layers of the volume to complete a single growing step.

In contrast, in the point-based approach, seeds are grown based on the currently active voxels that only consist of a small percentage of total voxels, rather than iterating through the entire volume for every frame (e.g., 100 vs. 512³ computation cycles), thus achieving dramatic performance improvement with local updates. In addition, the methods and systems also enable the processing of multiple seeds from the input sketch in parallel fashion and allows for dynamically modifying the threshold, which is effective for the visualization and manipulation of medical datasets.

### GPU-Based Point Radiation

In one embodiment, a GPU-based point radiation technique provides a fundamental building block for creating a set of real-time volume manipulation tools (such as, direct drilling, lasering, peeling, cutting, and/or pasting). To implement the technique, a set of 3D points (from the manipulation tools) are created and associated to the existing voxels. Based on the tool, the intensity values of the corresponding places in the dataset are changed (e.g., by removing the material). The binary use of points creates aliasing artifacts. To address this issue, it can be assumed that each point has a continuous field of energy (radiation) that drops smoothly off to zero. Taking the radiation into consideration increases intensively the computational load for an interactive application. This is addressed by taking advantage of the programmable graphics hardware. In fact, point radiation extends from a hardware supported function—point sprite. Point sprite is a two-dimensional billboard method for rendering a textured image from a single point in space; whereas point radiation establishes a three-dimensional metaphor for rendering a filtered volume from a point sample. The basic idea of point radiation is also close to the concept of 2D splatting, which is first described by Westover (see Westover, L., “Footprint Evaluation for Volume Rendering,” Proc. of SIGGRAPH '90, pp 367-376 (1990)), as a footprint evaluation for object-order volume rendering. The splatting scheme allows every input sample to be treated individually and therefore it is suitable for parallel execution. The point radiation method, as an energy distribution process, produces a three-dimensional footprint.

The concept of point radiation may also be similar to the field function of point's primitive in implicit modeling (see Bloomenthal, J., Introduction to Implicit Surfaces, Morgan Kaufmann Publishers Inc. (1997)). In implicit modeling, various primitive volumes may be used and then are blended with a tree-like structure (see Wyvill, B. et al., “Extending the CSG Tree—Warping, Blending and Boolean Operations in an Implicit Surface Modeling System,” Computer Graphics Forum 18, pp 149-158 (1999)). The methods and systems do not necessarily rely on implicit functions and sorting hierarchical blending operators. The methods and systems can work on point primitives and can directly operate on volumetric datasets. Therefore, methods and systems may be viewed as falling in the category of point-based modeling and rendering.

### Point Radiation Methodology

For the input 3D point p=(x, y, z), a Gaussian distribution function is used for spreading energy radially into the volume space around p. The Gaussian function smoothes neighboring elements and provides high-quality anti-aliased rendering. The kernel of Gaussian function is defined by a radius R, in terms of number of voxels. The 2R×2R×2R region forms a 3D footprint in the volume space. To compute the weight ω at a particular voxel v of the footprint, one can apply 3D Gaussian function: ω=Gaussian3D(v). In an embodiment, a simple summation is used to accumulate the energy contributions from all input points.

For implementing the point radiation technique, a geometry shader is utilized, along with its ability to render to 3D textures. The geometry shader allows point primitives to be amplified and redirected to any location in the 3D output texture. One possibility is to use these features for creating and evaluating the 3D footprint of the input point and blend it with the output volume. However, if one directly instructs the geometry shader to generate the set of all footprint points, the geometry shader may become overloaded. To reduce the number of points processed by the hardware, a point sprite hardware acceleration function can be utilized. It allows a point to be rasterized into a square region consisting of fragments containing relative coordinates with respect to the input point (e.g., fragment at the lower-right corner has coordinate (1, 1)). To reconstruct the set of 3D footprint voxels, a stack of 2D point sprites can be utilized to largely reduce loads on the geometry shader.

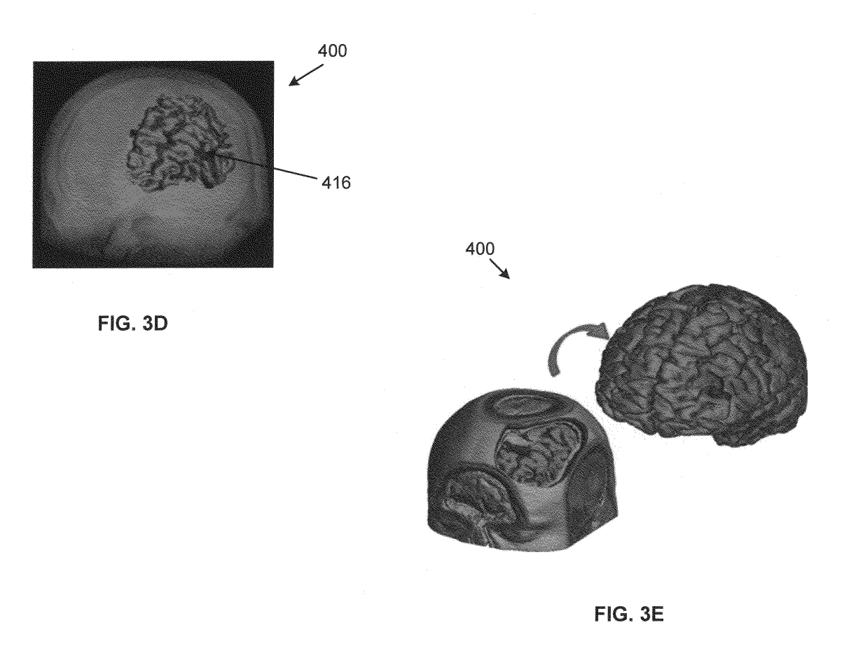

FIG. 4 illustrates reconstructing a set of 3D footprint voxels from 2D point sprites according to an embodiment. As shown, points are emitted as 2D point sprites by a single geometry program and reconstructed into 3D footprint voxels. Each 2D point sprite contains automatically generated texture coordinates ranging from (0, 0) to (1, 1).

To compute the energy at a footprint voxel, the 3D Gaussian function is sampled. Theoretically, this function could be sampled by evaluating it at a 3D coordinate. But this requires the storing of a 3D texture in the GPU memory to represent the Gaussian kernel. When composing a high resolution sampling, a large amount of memory has to be allocated for storing the 3D texture. However, the 3D Gaussian function can be evaluated by multiplying a 2D and a 1D Gaussian functions as follows:

$$\begin{matrix}f ( x , y ) f ( z ) = {a}^{2} exp ( - \frac{{( x - {x}_{0} )}^{2} + {( y - {y}_{0} )}^{2}}{2 {b}^{2}} ) a exp ( - \frac{{( z - {z}_{0} )}^{2}}{2 {b}^{2}} ) \\ = {a}^{3} exp ( - \frac{{( x - {x}_{0} )}^{2} + {( y - {y}_{0} )}^{2} + {( z - {z}_{0} )}^{2}}{2 {b}^{2}} ) \\ = f ( x , y , z ) ,\end{matrix}$$

where a>0 and b are the parameters of Gaussian function and (x₀, y₀, z₀) is its center. This scheme reduces memory consumption since it is only necessary to store a 2D texture and a 1D texture on the GPU. Then, the Gaussian functions are reconstructed using programmable graphics hardware. To begin the radiation process, the geometry shader receives the position and attributes of an input point p fetched via the vertex shader. Next, the point radiation is computed by first transforming the position of p into screen-coordinate to prepare it for rasterization. Then, the first layer of the 3D footprint is computed with a viewport transformation scheme using the equation:

layer0=round(p_{z}/ζ)−R,

where p_{z} is a normalized depth value of p and ζ is the depth of the voxel dimensions. Next, the process iterates through layer0 to layer(2R−1) and duplicates a point primitive for each layer to reconstruct the 3D footprint. Each point should be associated with two attributes: (1) the weight value in the z direction, ZWeight, sampled from the 1D Gaussian texture computed from the normalized layer coordinate and (2) the sample value s of point p (e.g., intensity value). After the rasterization step, the set of points emitted by the geometry shader are converted into 2D point sprite fragments. In the fragment shader, the 2D Gaussian texture is looked up with the 2D point sprite coordinate, and the result is combined with ZWeight to form a 3D energy value ω corresponding to a 3D footprint location. The final fragment value is then combined with the sample value s and blended into the radiation volume.

### Interactive Volume Tools

As discussed, the GPU-based point radiation technique provides a building block for creating a set of real-time volume manipulation tools that include, but are not limited to, direct drilling, lasering, peeling, cutting, and/or pasting. Based on the teachings herein, a person having ordinary skill in the relevant art(s) would readily understand that other volume tools may be used and integrated with the methods and systems. One possible implementation of the GPU-based point radiation tools include medical illustrations depicting clinical procedures using physical operations like drilling and peeling. According to an embodiment, the user specifies a closed-curve region directly over the volume to define the tip shape of the sculpting tool or the volumetric region of interest for uncovering. This closed-curve region is then used to construct a computational mask in which each element can penetrate/cut through the volume using local geometric property such as normal directions on the volume surface.

### Mask Generation

The first step is to generate a binary computational mask, where 1 indicates the pixels are contained in the sketched area and 0 otherwise. Therefore, a closed curve is necessary to divide the area to inside and outside. This closed curve can be defined in two ways (1) as simple shapes (circles, squares, etc) approximating specific sculpting tools or surgical medical devices or (2) as closed curves freely sketched by the user approximating surgical cuts, for instance. The freely-sketched curve is created by enclosing the piecewise linear curve strokes created from the input points. Sketching a fine curve on the screen requires fast processing of the stylus input when complex rendering is involved. Since rendering the volume data is a costly operation, simultaneously sketching and rendering the volume is deemed to degrade the curve quality. In order to obtain smooth sketching, the background rendering (i.e., the volume raycasting) is frozen by saving the entire scene to a texture. Thus when the user places strokes on the screen, the screen-sized texture is rendered first followed by the input strokes. This avoids delays caused by the concurrent rendering of both the sketch and the volume data. To generate the mask, the enclosing sketch area is filled using the stencil buffer with a 1-bit color. Then the content of the stencil buffer is saved as a texture.

Direct use of a binary mask for sculpting or removing material from the volume can introduce aliasing effect. To avoid aliasing in the image space, the mask generation process is modified, and a post-filtering step is performed. Instead of using a mask with a binary format, floating-points are used to represent intermediate values between areas covered by the sketch and outside the sketch. This method produces a smooth blending on the boundary of the sketched region and further prevents aliasing in the volume space. In the post-filtering process, stochastic sampling is adapted, and jittering is applied on a regular grid. Jittering is a method that trades aliases with noise where new pixel positions are sampled within a sub-pixel (i.e., grid cell)—the final color is then reconstructed with some scheme. The cubic B-spline reconstruction filter is chosen as it provides smooth results while maintaining sharpness and details.

### Drilling

As discussed, one GPU-based point radiation tool is a drilling tool that allows the user to carve into the volume by sweeping a mask along the viewing direction. The mask represents the shape of the drill's tip that can be circle, ellipse, square, or any other shapes sketched by the user. The drilling mask is matched to the view plane. This, in addition to the use of viewing direction, are natural selections and help to reduce the user interventions.

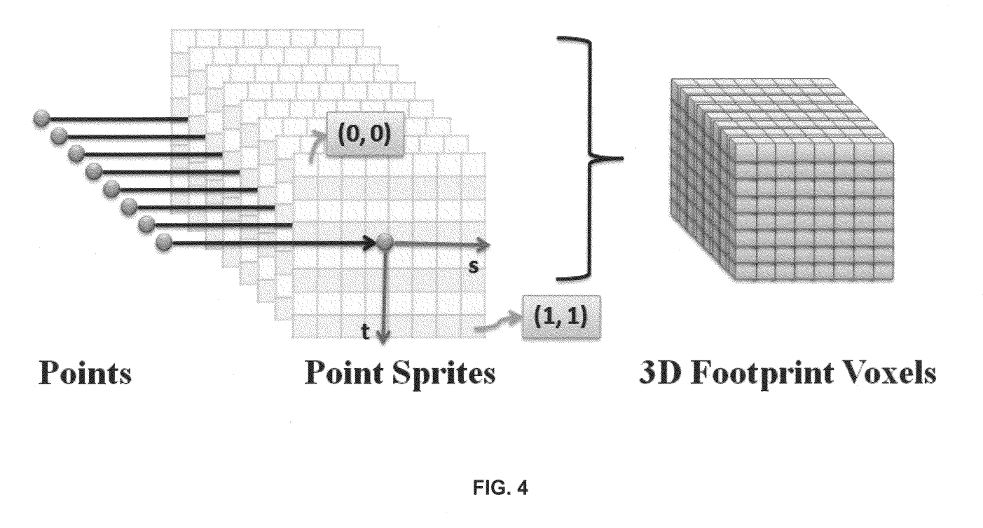

FIGS. 5A-5B illustrate an example of a user operating a drilling tool according to an embodiment. More specifically, FIG. 5A shows drilling the super-brain data with a square mask, raycasting into the volume to find surface points, and executing point radiation along the view-direction. FIG. 5B shows applying multiple pressures to cut through the skull.

Upon receiving a pressure change (from a stylus) or slight movement, the surface points are found by casting rays from the mask plane into the volume space, as shown in FIG. 5A. To perform drilling, the mask elements are attached to the surface points and execute individual point radiation operation. This process is repeated according to the depth of drilling: depth=depthₘₐₓ×pressureₙ, where depthₘₐₓ is a maximum drilling depth allowance for each surface detection operation; pressureₙ is the instantaneous pressure normalized to [0, 1], either supplied by a stylus or from a second input source; and depth is an integer defining the succession for the mask radiation process. Based on the inventors' observations, setting the depthₘₐₓ value to the range of 8 to 12 is suitable for a volume of size 256³. Having a maximum drilling depth of 12 prevents excessive removal of volume materials for every stylus input and help maintain stylus responsiveness. Successive mask operations offset the positions of the mask elements with a small amount (i.e., relative to the size of a voxel) along the view-direction.

### Lasering

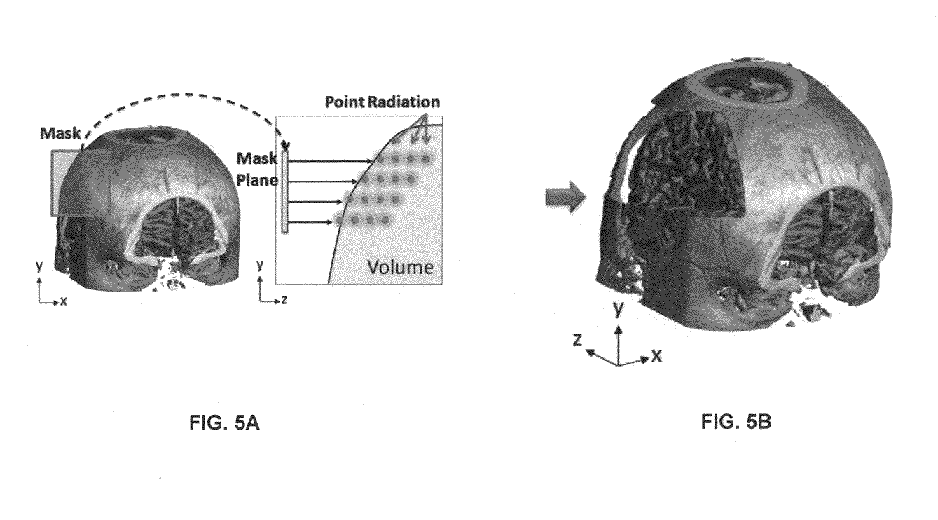

To enable more flexibility, another carving tool is provided that is slightly different from the drilling tool and can simulate 3D laser wand. FIG. 6A-6B illustrate an example of a user operating a lasering tool according to an embodiment. More specifically, FIG. 6A illustrates lasering a super-brain dataset with a circular mask, raycasting into the volume to find surface position and normal, and executing point radiation parallel to the mask. FIG. 6B illustrates moving and applying various pressures to remove the skull layer.

In the lasering tool, the mask is swept along the normal of the visible surface. And, the laser mask (the tool's tip) is orthogonal to the gradient of visible surface. As the mask moves, a surface point is found by casting a single ray from the center of the mask into the volume space. The geometric information on this point, surface position and normal, is then used for relocating and orienting the mask in 3D. When pressure is applied on the mask, point radiation is executed by emitting points parallel to the oriented mask (FIG. 6A). The depth of lasering is computed similar to the drilling tool with the amount of input pressure applied from a stylus. By setting the maximum depth value to the range of 18 to 22, it works well for a volume of size 256³ and prevents the laser operation from removing excessive surface layers. To minimize the user input, in the final implementation, flexibility for changing the sweeping direction is limited, although the framework is capable of this feature.

### Peeling, Cutting and Pasting

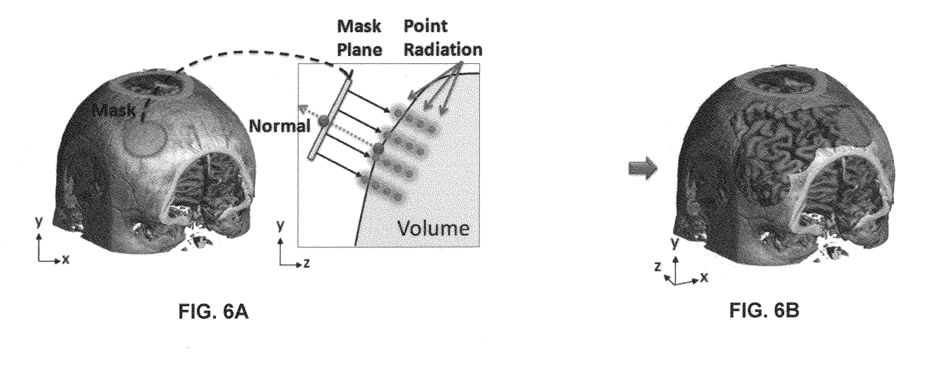

To facilitate removing a large surface region at once (e.g., opening the skull), a peeling tool is provided. FIG. 7A-7B illustrate an example of a user operating a peeling tool according to an embodiment. More specifically, FIG. 7A illustrates peeling the skull with a free-form mask, parallel raycasting into the volume to find separate surface position and normal, and executing point radiation along the detected inverse normal directions. FIG. 7B illustrates removing surface layers and pasting back the skull with a second rendering pass.

The peeling operation can be seen as wrapping a surface region sketched by a user into a mask. To create the impression of peeling, each point of the mask, associated to a point on the visible surface, should move along the normal of the surface at that point. Therefore, the peeling tool has a variable sweeping direction as opposed to the drilling or lasering tool's constant direction. Consequently, the condition of mask peeling holds only if the target surface contains a smooth change of gradients. To precisely control the peeling layers, the peeling operation is performed by adjusting a slider or dragging a pen on the tablet instead of applying pressures. After composing the peeling mask, parallel rays are cast from the mask plane into the volume space to find individual surface position and normal direction for each element on the mask (FIG. 7A). To perform the peeling operation, the mask elements are relocated to the detected surface points and emit independent point radiation along the inverse normal as cutting path.

To simultaneously indicate the sculpted portion, a cut and paste tool is provided that allows the region cut by the peeling tool to be pasted back with a different position and orientation in the scene (FIG. 7B) through an additional rendering criteria. In a cut scene, voxels with associated radiation values (i.e., sampled from the radiation volume) less than 0.5 are rendered. In a paste scene, the visibility criteria is reversed (i.e., those with radiation values greater than or equal to 0.5 are rendered instead). To simultaneously display the cut and paste scene, dual-rendering is performed with the GPU-based raycasting engine. As the radiation values range from 0 to 1.0, the value 0.5 can be selected as a natural candidate for distinguishing the cut and paste rendering.

### Interactive Seeded Region Segmentation

Segmentation is often broken down into edge-based or region-based methods. Each of these in turn may be manual or computer assisted (including completely automatic). Along the edge-based category, a typical manual segmentation process requires a trained specialist to draw contours around the region of interest (ROI) on cross-sectional images. These contour lines are then linked and reconstructed into a 3D representation for further analysis. This procedure can become a challenging task if the target is, for example, blood vessels in the brain, which by nature involves complex shape with many components unpredicted turning directions. In the seeded region growing algorithm, the algorithm starts from the selected seed point (the parent seed) as the current voxel and moves to adjacent voxels (the child seeds) with feature values (such as intensity or gradient magnitude) close to the values in the current voxel. Standard CPU implementation of this method (e.g., breath first search) requires storing the seeds in a queue with sequential processing of the neighbors (adjacent voxels). For a 512³ volume, this amounts to 805 million iterations every frame. In the context of high-quality rendering with raycasting, the segmentation result (i.e., a volume) also needs to be transferred from CPU to GPU (per-frame), further impeding interactive control of segmentation. Recent advancements in programmable hardware bring the potential of accelerating the region growing process. However, the architecture of parallel memory access on the GPU makes it hard to parallelize the seed growing process, which requires a single seed to finish with its exploration operations before another seed can proceed. The methods and systems, however, include a parallel execution environment that specifically addresses these shortcomings for planting and progressing seeds, as discussed below.

### GPU-Based Segmentation Framework

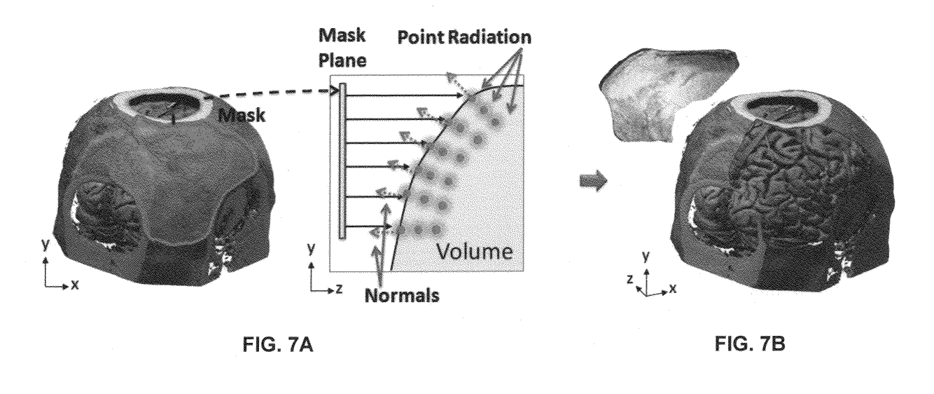

FIG. 8 illustrates an overview of the GPU-based segmentation framework according to an embodiment. As shown, the processing initiates from the source seed collection (1), enters the processing unit, exchanges seed growing information with the seed volume (2), and outputs the result in the destination seed collection (3). The result is point-radiated into the segmentation volume (4) for smooth rendering. The entire process is repeated (5) by swapping the source and destination seed collection.

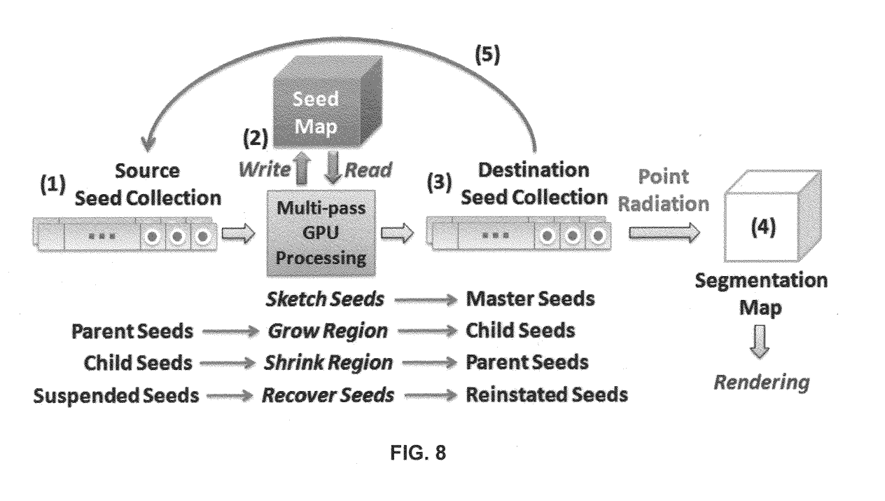

In an embodiment, the GPU-based technique includes four parallel functions: Sketch Seeds, Grow Region, Shrink Region, and Recover Seeds. Each function takes a set of input seeds to produce output seeds with a self-feedback loop (as shown in FIG. 8). The Sketch Seeds function converts user strokes into master seeds which are used to initiate the segmentation process. The Grow Region function expands the set of parent seeds to produce child seeds. This function also marks the voxels that could not be advanced (i.e., due to threshold constraints) as suspended seeds. The Shrink Region function and Recover Seeds function support the dynamic control for thresholding. The Shrink Region function reverses the region growing steps. And finally, the Recover Seeds function allows previously suspended seeds to be reinstated when threshold constraints are modified. These functions are evaluated on the GPU with multi-pass processing techniques and they need to have access to seeds' information. The seeds' information is stored in vertex buffers called a seed map. It is used to control the segmentation process by mapping the seeding states (such as master, parent, child, suspended, or reinstated seeds) into respective voxels. Communications with the seed map is done using the geometry shader, with its unique capability of reading/writing 3D seed points into any location in the volume. Each function starts by feeding a source seed collection, exchanging seed growing information with the seed map, and writing the result into the destination seed collection. For the rendering purpose, the result of each function operation is also recorded in a 3D texture called a segmentation map. Direct use of the seed collection in the segmentation map produces aliasing artifacts due to its binary values (segmented/not segmented). This can be seen in FIG. 9A which illustrates a partial segmentation of ventricles using a binary segmentation map without point radiation.

To obtain smooth and high quality rendering of the segmentation result, point radiation is utilized to convert the collected seeds into blended regions in the segmented map. This can be seen in FIG. 9B which illustrates partial segmentation of ventricles using a binary segmentation map with point radiation. When the result is rendered, the segmentation map is sampled using 0.5 as a natural candidate to distinguish between segmented and un-segmented regions. Finally, the entire simulation and rendering process is repeated by exchanging the source and destination seeds.

### Sketch-Based Seeding

To allow quick multi-seeding directly in 3D, sketches are used to indicate seeds on the displayed volume. Multiple input strokes are mapped onto surface points of the volume using raycasting. The stroke is first discretized and stored in a binary 2D sketch texture. Each pixel on the texture is then projected into the volume space to collect surface points based on rendering parameters. For each point on the surface, the closest voxel is found as the seed. However, as one or more of the detected surface points may be contained within the same voxel due to variance of volume resolution, it is necessary to remove duplicated voxels to avoid multiple seed points at the same voxel location. To ensure that unique seed points are collected, the collection of detected voxels is first stored in a list. Then, for each of the non-repeating voxels in the list, the respective voxel is un-projected into a second list, storing the master seeds that map one-to-one to unique voxels in the volume.

### Parallel Region Growing/Shrinking

Region growing is enabled while exploring multiple seeds simultaneously. During the growing process, the region growing algorithm starts from a set of parent seeds and advances to a set of child seeds using a breadth-first search (BFS) algorithm. In a number of region growing situations, different materials such as tissues and blood vessels have close intensity values and cannot be easily controlled by means of thresholding.

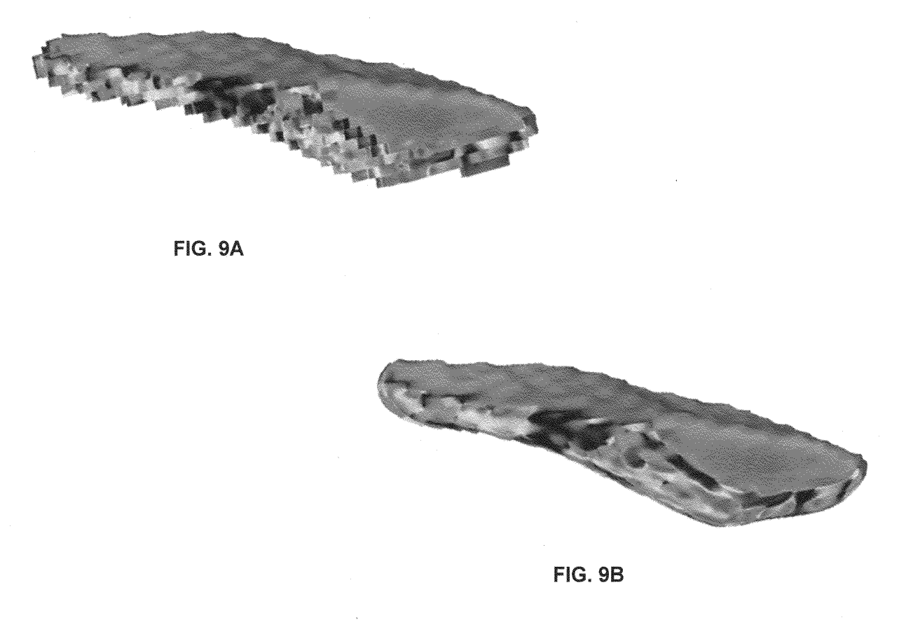

This can be explained with reference to FIGS. 10A-10D, which illustrate a segmentation of carotid and cerebral arteries from the angiogram dataset. FIG. 10A illustrates sketches on high intensity data with X-ray and MIP rendering. FIG. 10B illustrates the outcome as a forward region grows in parallel. FIG. 10C provides an illustration of the forward region growing resulting in undesired tissues, and FIG. 10D shows extra growth being removed with region shrinking.

For example, the user initially sketches seeds on the blood vessels (FIG. 10A), but during the growing process, a group of child seeds may start to spread to unrelated materials (FIG. 10C). However, in additional to forward growing, region shrinking is provided that reverses the grown regions and rewinds the segmentation (FIG. 10D). This provides the user an opportunity to undo partial region growing and cease the segmentation process. Afterwards, the user could resume the growing process by re-sketching seeds on the remaining part of the original intent.

To have the ability of shrink, parent/child relationship are tracked in the region growing. A seed map is used to save the parent information for each seed. With parallel execution, a conflict arises when two or more parent seeds are concurrently exploring the same voxel location as a child. Saving all of the possible parents at the same voxel location (child) requires a bigger field for the seed map's memory unit. To avoid this, the possibility of multiple parents are prevented simply by over-writing the previous values when a new parent arise. This means that each seed (as a child) has the information of the most recent parent in the growing process.

To shrink the grown region, first the segmented voxels occupied by the last set of child seeds are erased, and then their neighboring voxels are searched to find potential parent seeds. The reversing process is based on the order in which the child seeds are processed; therefore, it is not guaranteed that the shrinking algorithm always returns to the original set of parent seeds while it is a plausible solution. Another benefit of the reverse operation is that additional strokes can be drawn to indicate the area of removal. In this case, the sketched seeds become the source (i.e., the child seeds) of the reversing operation, allowing targeted region removal.

In addition to searching for the child seeds in the parallel region growing process, the voxels that could not be advanced (i.e., due to threshold constraints) are marked as suspended. The suspension information is recorded using the seed map. When thresholds are modified, the suspended seeds are lookup from the seed map, and they are allowed to re-participate in the normal region growing/shrinking iterations.

### RESULTS AND DISCUSSION

In an embodiment, the methods and systems can be implemented on an Intel Core2 Duo, with GeForce 8800 GTX, 768 MB graphics card. Raw and pre-segmented volumetric medical datasets can be selected in both CT or MRI modality. In an embodiment, the system is configured to achieve relatively fast computation rates in mask construction (80 ms), volume tools (50 fps on average), sketching seeds (60 ms), dynamic region growing (58 fps) and high-quality raycasting rendering (50 fps in X-ray mode and 60 fps in surface mode), with screen recording resolution of 1230×870. Note that the performance of point radiation scales with the amount of parallel (or stream) processors on the hardware. Based on the inventors' observations, it was discovered that a kernel radius of 3 produced prominent results with the best performance for data ranging from 128³ to 512³.

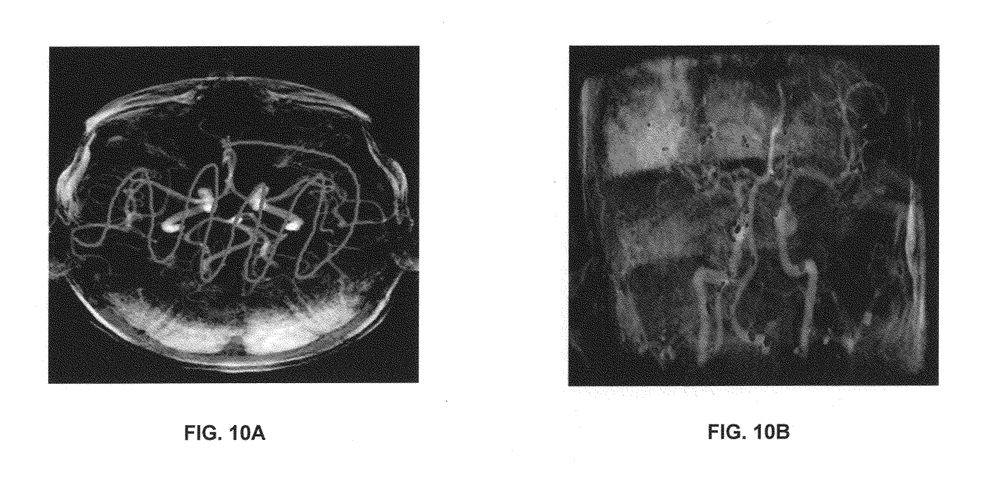

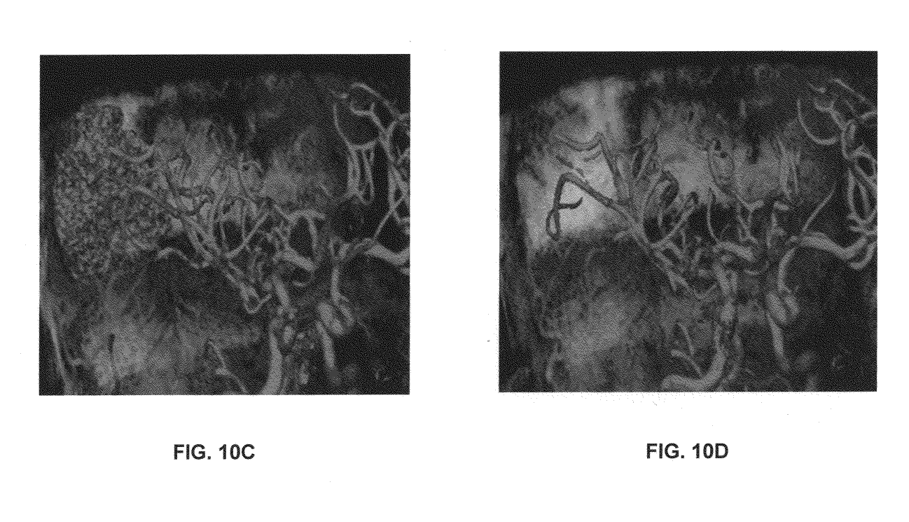

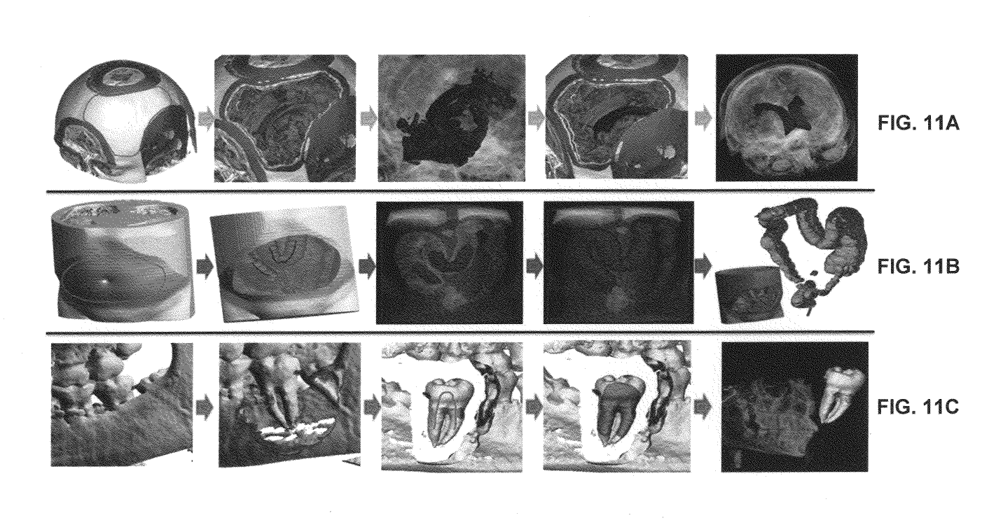

As discussed above, FIG. 3 demonstrates peeling and segmentation of a super-brain dataset (MRI, 256×256×256). FIG. 11A however illustrates peeling of the skull and segmentation of the left and right lateral ventricle from the same super-brain dataset. The process illustrated in FIG. 11A shows opening the skull with the peeling tool, sketching seeds on the left ventricle, regions growing into surrounding material, reversed growing, sketching seeds on the right ventricle and completing segmentation.

FIG. 11B illustrates of peeling of the abdominal wall and segmentation of the colon from an abdomen dataset scanned in supine orientation (CT, 512×512×426). The process illustrated in FIG. 11B shows opening the abdominal wall with the peeling tool, placing multiple strokes on the colon, region growing in parallel, covering the entire colon, and pasting the segmented part in isolation.

FIG. 11C illustrates lasering, drilling, and segmentation of a molar tooth from a skull dataset (Rotational C-arm X-ray scan of phantom of a human skull, 256×256×256). The process illustrated in FIG. 11C shows lasering the skull with a circular mask, removing occluding bone, sketching seeds on the molar tooth, region growing, and pasting the segmented tooth with zoom.

FIG. 10 illustrates seed sketching and segmentation of carotid and cerebral arteries from the angiography dataset (3T MRT Time-of-Flight of a human head, 256×320×128).

### CONCLUSION AND ALTERNATIVE IMPLEMENTATIONS

A GPU-based point radiation technique is provided as a real-time manipulation primitive in the context of high quality volume manipulation, sculpting, segmentation, and visualization (raycasting rendering). Instead of the traditional way of browsing from hundreds of cross-sectional slices or adapting 3D devices, a point-based strategy is implemented, and a set of interactive volume tools for direct drilling, lasering, peeling, cutting, and pasting are provided. With point radiation, an interactive region growing segmentation system can be provided to support multiple seeds planting with sketches. To effectively handle large medical volume datasets, the embodiments can be implemented with programmable hardware to thereby achieve dramatic performance improvement (with local updates) as compared to the 3D texture-based (global) approach in volume clipping and region growing segmentation.

Other implementations include performing user/clinical studies in specific medical domains. The set of volume tools, are provided by way of example and not limitation, other volume tools may be used and modeled after specific application domains such as virtual surgery. It would also be useful to extend the point radiation technique to create a non-spherical radiation in space and possibly generate a variety of other sculpting primitives and cutting tools. The GPU-based framework can be adapted with physically-based volume deformation in domains where real-time, intuitive cutting and volume manipulation is essential (e.g., virtual surgery). Moreover, the framework can provide a ground for a real-time implicit modeler.

The figures herein are conceptual illustrations allowing an explanation. It should be understood that various aspects of the embodiments could be implemented in hardware, firmware, software, or a combination thereof. In such an embodiment, the various components and/or steps would be implemented in hardware, firmware, and/or software to perform the functions. That is, the same piece of hardware, firmware, or module of software could perform one or more of the illustrated blocks (e.g., components or steps). Unless explicitly stated otherwise herein, the ordering or arrangement of the steps and/or components should not be limited to the descriptions and/or illustrations hereof.

In software implementations, computer software (e.g., programs or other instructions) and/or data is stored on one or more machine readable media as part of a computer program product, and is loaded into or written on a computer system or other device or machine via a removable storage drive, hard drive, or communications interface. The software described herein need not reside on the same or a singular medium in order to perform the embodiments described herein. Computer software can be implemented by any programming or scripting languages, such as C, C++, Java, Javascript, Action Script, or the like. Computer programs (also called computer control logic or computer readable program code) are stored in a various memory types, including main and/or secondary memory, and executed by one or more processors (controllers, or the like) to cause the one or more processors to perform the functions as described herein. In this document, the terms machine readable medium, computer program medium and computer usable medium are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, or the like); or the like.

Notably, the figures and examples above are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration. While various embodiments have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for interactive volume manipulation, sculpting, segmentation, and visualization, the method comprising:
accessing three-dimensional point texture data including a plurality of seed voxels for a graphic image;
visualizing the graphic image on a user interface based on the texture data;
receiving user input to define an input sketch specifying a closed-curve region of the graphic image;
designating the seed voxels associated with the closed-curve region as active seed voxels;
processing the active seed voxels in parallel to grow each of the active seed voxels without growing seed voxels not designated as active voxels; and
visualizing a segment of the graphic image based on the processed active seed voxels.

2. The method of claim 1, further comprising:
storing state information associated with each active seed voxel in separate three-dimensional buffers.

3. The method of claim 2, further comprising:
querying the three-dimensional buffers to enable dynamic manipulation of the graphic image.

4. The method of claim 3, wherein dynamic manipulation includes at least one of direct drilling operation, lasering operation, peeling operation, cutting operation, or pasting operation.

5. The method of claim 3, wherein dynamic manipulation includes at least one of reversing a previously grown region or reinstating a previously grown region.

6. A computer program product comprising a computer-readable medium having a computer-readable program code embodied therein, the computer-readable program code adapted to be executed to implement a method for interactive volume manipulation, sculpting, segmentation, and visualization, the method comprising:
accessing three-dimensional point texture data including a plurality of seed voxels for a graphic image;
visualizing the graphic image on a user interface based on the texture data;
receiving user input to define an input sketch specifying a closed-curve region of the graphic image;
designating the seed voxels associated with the closed-curve region as active seed voxels;
processing the active seed voxels in parallel to grow each of the active seed voxels without growing seed voxels not designated as active voxels; and
visualizing a segment of the graphic image based on the processed active seed voxels.

7. The computer program product of claim 6, where the method further comprises:
storing state information associated with each active seed voxel in separate three-dimensional buffers.

8. The computer program product of claim 7, where the method further comprises:
querying the three-dimensional buffers to enable dynamic manipulation of the graphic image.

9. The computer program product of claim 8, wherein dynamic manipulation includes at least one of direct drilling operation, lasering operation, peeling operation, cutting operation, or pasting operation.

10. The computer program product of claim 8, wherein dynamic manipulation includes at least one of reversing a previously grown region or reinstating a previously grown region.

11. A system for interactive volume manipulation, sculpting, segmentation, and visualization, the system comprising:
a CPU;
memory coupled to the CPU;
a display coupled to the CPU; and
a user input device coupled to the CPU;
where the system is configured to execute computer-readable program code to implement a method for interactive volume manipulation, sculpting, segmentation, and visualization, the method comprising:
accessing three-dimensional point texture data including a plurality of seed voxels for a graphic image;
visualizing the graphic image on a user interface based on the texture data;
receiving user input to define an input sketch specifying a closed-curve region of the graphic image;
designating the seed voxels associated with the closed-curve region as active seed voxels;
processing the active seed voxels in parallel to grow each of the active seed voxels without growing seed voxels not designated as active voxels; and
visualizing a segment of the graphic image based on the processed active seed voxels.

12. The system of claim 11, where the CPU further comprises a Graphics Processing Unit (GPU).

13. The system of claim 11, where the method further comprises:
storing state information associated with each active seed voxel in separate three-dimensional buffers.

14. The system of claim 13, where the method further comprises:
querying the three-dimensional buffers to enable dynamic manipulation of the graphic image.

15. The system of claim 14, wherein dynamic manipulation includes at least one of direct drilling operation, lasering operation, peeling operation, cutting operation, or pasting operation.

16. The system of claim 14, wherein dynamic manipulation includes at least one of reversing a previously grown region or reinstating a previously grown region.
